(19) United States
(12) Patent Application Publication
(10) Pub. No.: US 2005/0070330 A1
(43) Pub. Date: Mar. 31, 2005

(54) Method of matching between a mobile phone and a personal card

(76) Inventors: Christophe Nicolas, Preverenges (CH); Stephane Joly, Epesses (CH)

Correspondence Address: HARNESS, DICKEY & PIERCE, P.L.C., P.O. BOX 8910, RESTON, VA, 20195, US

(21) Appl. No.: 10/936,764

(22) Filed: Sep. 9, 2004

(30) Foreign Application Priority Data
Sep. 30, 2003 (CH) 2003 01660/03

(51) Int. Cl. H04Q 7/20

(52) U.S. Cl. 455/558

(57) ABSTRACT

The aim of this invention is the use of a mobile telephone or mobile equipment for localized interactive functionalities and to demonstrate to a local device that a certain individual is indeed the holder of a given telephone number. This problem is resolved thanks to a matching method between an item of mobile equipment comprising the data relating to its identification and a personal object of identification disposing of at least a unique number, this method being carried out by a matching terminal and comprising the following stages: reading of the unique number of the personal object by a reader of the matching terminal, initialization of a first communication between the mobile equipment and the matching server, transmission of a unique code by the matching terminal to the mobile equipment, transmission of this unique code by the mobile equipment towards a matching server, detection and storage of the data relating to the identification of the mobile equipment by the matching server, transmission of the unique code and of the unique number to the matching server by the terminal, association of the unique number of the personal object with the data relating to the identification of the mobile equipment.

### FIELD OF THE INVENTION

The present invention refers to the domain of the use of additional services for a mobile telephone.

### BACKGROUND OF THE INVENTION

Different methods have been proposed for services with added values concerning the mobile telephone such as described in the patent EP 0748 135.

One of the aspects of these methods is to take advantage of the knowledge of the location of a user to transmit messages to said user pertaining to attractions or events specific to this location.

The user's location is in fact determined in relation to the closest transmitter. Therefore, data such as the presence of a vegetarian restaurant or sales are transmitted to these users.

Nowadays, this transmission is made by means of short messages SMS but the transmission protocol can develop including images (MMS), for example.

This method is rarely used since few users are willing to receive this type of message as they know that the majority of said messages will be of no interest to them.

In fact, in a town for example, a transmitter can cover an important number of users some of whom will be at work, while others will be at home and only a small number, who are out, would be susceptible to be interested.

It is thus highly recommended to request the approval of the user before proceeding with the diffusion of such messages.

A first solution consisted in requesting users to send a short message to a predefined number in order to register with the service diffusing these messages. This solution, although it works in principle, encounters certain reticence due to its relative complexity. In fact, to send a message is a voluntary gesture that takes a certain amount of time.

Another solution consists in transmitting, from the mobile telephone, its identifier (telephone number) to a reception terminal by means of infrared or by radio waves (Bluetooth). The problem encountered originates from the multiplicity of the standards of communication and their poor usage. This function, which consumes much energy, is generally deactivated in the majority of telephones.

Ideally, the mobile telephone would be equipped with a non-contact smart card allowing the transmission of the SIM card identifier. Today, this is not possible since the telephones are not equipped such functions. Operators are reluctant, due to security problems, to open an access channel to the SIM card by a simple non-contact card reader.

### OBJECT OF THE INVENTION

Therefore, the aim of the present invention is to use the mobile telephone or mobile equipment for localised interactive functionalities and to prove to a local device that a certain individual is the holder of a given telephone number.

### SUMMARY OF THE INVENTION

This problem is resolved thanks to a matching method between mobile equipment comprising the data relating to its identification and a personal identification object having at least one unique number, this method being carried out by a matching terminal and comprising the following steps:
reading of the unique number of the personal object by a matching terminal reader,
initializing a communication on the mobile equipment with the matching server,
generating a unique code by the matching terminal and transmitting it to the mobile equipment,
transmitting this unique code by the mobile equipment towards a matching server,
detecting and storing the data relating to the identification of the mobile equipment by the matching server,
transmitting the unique code and the unique number to the matching server by the terminal,
associating the unique number of the personal object with the data relating to the identification of the mobile equipment.

The presence of this unique code guarantees the security of the procedure. This code assures that it is really the mobile equipment that is present locally which is related to this matching mechanism. This avoids an incorrect telephone number being associated with another personal object.

There are several methods for transmitting this unique code to the mobile equipment. The simplest is to display this code and to request the user to introduce this code using the keyboard of the mobile equipment.

A second method consists in placing the mobile equipment on an emitting device DTMF integrated into the matching terminal. The tones DTMF are emitted by the emitting device and transmitted to the microphone of the mobile equipment. These signals are then transmitted to the matching server serving to demonstrate the presence of the mobile equipment next to the personal object.

The association between the data of the mobile equipment and the personal object can be carried out according to different methods:
the personal object does not store any data. This allows the use of a read only card such as a bar code or a magnetic card and even a non-contact read only card. It is the matching server that associates the unique number of the personal object and the telephone number in its memory.

At each presentation of the personal object to a reading terminal, a request will be made to this memory to find the corresponding telephone number.
the personal object stores the identification of the telephone in its memory. Therefore, during the reading of this card, the telephone number can also be transmitted.
the personal object stores the data that are also stored by the matching server. According to the requirements, the telephone number is extracted directly from the personal object or can be obtained by the server. It is also possible to verify that the data of the personal object corresponds to the data on the server.

### BRIEF DESCRIPTION OF THE DRAWING

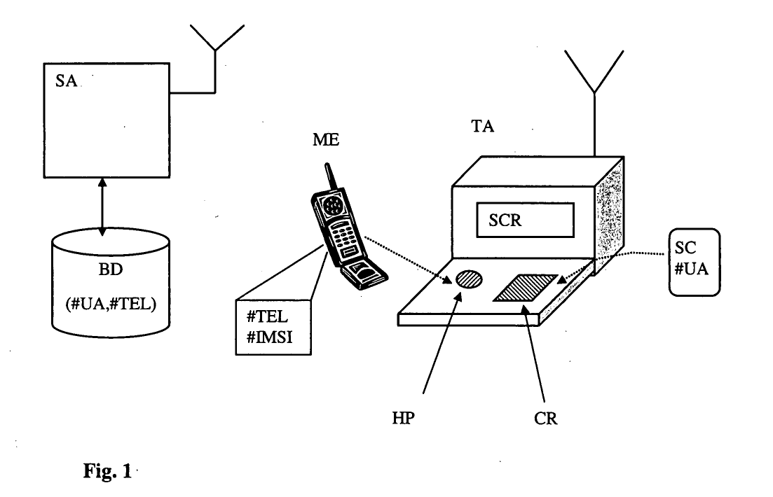

The invention will be better understood thanks to the following detailed description that refers to the enclosed drawing that is given as a non-limitative example, in which the FIG. 1 shows the different elements of the invention.

### DETAILED DESCRIPTION OF THE PREFERRED EMBODIMENTS OF THE INVENTION

In FIG. 1, the matching terminal TA comprises an area intended to receive the personal object SC and the mobile equipment ME. The area intended to receive the mobile equipment ME comprises a loudspeaker HP that allows the transmission of DTMF signals. Therefore, when the mobile equipment ME is placed in this area, the signals can be transmitted to the mobile equipment ME by the matching terminal TA.

The matching terminal TA reads the unique number UA that is to be found on the personal object SC and stores said number.

According to a first variant, called automatic, the terminal uses the loudspeaker HP to communicate with the matching server SA. As indicated above, the user is invited to select the number corresponding to the matching server SA. Once connected, the terminal TA takes over and can interact with the matching server SA. It should be noted that the initialization of this connection between the mobile equipment ME and the server allows the secure identification of the mobile equipment ME by the server. The latter receives data such as at least the telephone number. If it concerns a server that is part of the equipment of the telephone operator, other data is available such as the unique number IMSI of the SIM card of the mobile equipment ME.

The server SA receives from the terminal, via the mobile equipment ME, a unique code that may be the unique number of the personal card SC placed on the CR card circuit reader. The server SA sends a message to the terminal that contains the unique number and the telephone number.

This unique code can be generated randomly in order to ensure that this is the terminal that is in connection with the matching server at a given time. This code is then returned to the terminal by the server that can make the link between this code and the unique number of the personal object that was placed on the reader for that purpose at the point of the emission of the code.

The exchanging of data can be carried out at different points in time. In fact, once the unique code has been transmitted to the matching server SA, the latter stores the telephone number of the caller, the unique code as well as the time of the transaction.

During a second step, the terminal TA can initiate a communication with the server SA and communicate to said server the unique code and the unique number of the personal object SC. Matching can thus be carried out in an off-line way, for example, at night. The transmission of a unique code during the connection between the mobile equipment and the matching server obliges an ill-intentioned third party to attack two communications which can be used in different ways. In fact, the connection between the server and the terminal will advantageously be of wired telephone type unlike the communication between the mobile equipment and the server. The database of the matching server SA matches the unique number UA together with the telephone number TEL.

The telephone number information of the mobile equipment is then transferred in the personal object SC of the user according to one of the embodiments. For security reasons, the telephone number is signed, either by a private emitting key that is in the terminal, or by a private key located in the matching server. In the latter case, at the time of the communication between the server and the terminal, in addition to the telephone number (or other information on the mobile equipment), the server also transmits the signature of the telephone number.

When a reader wishes to know the telephone number by reading the contents of the personal object, this reader can also verify that this number is authentic thanks to the public emitting key which is stored in each reader according to a common verification procedure.

According to the selected embodiment, the message sent back by the server to the terminal can be transmitted via the communication initiated by the user in a bi-directional way. During this communication, the matching server can transmit the identification data of the mobile equipment such as its telephone number.

This number can immediately be registered in the personal object if it comprises a memory for that purpose. Of course, this kind of communication is supervised with verification codes such a CRC or a Hash.

According to another embodiment, the message is transmitted in a different way, for example using a short SMS message. The communications between the terminal and the server can be encrypted thanks to the use of asymmetric keys.

According to a simplified embodiment of the invention, called without unique code, the matching terminal TA stores the matching data. Once the communication has been established between the mobile equipment ME and a trusted server, the latter sends back the telephone number in the form of signals DTMF. These signals are picked up by the matching terminal which thus disposes on one hand of the unique number UA of the personal object SC (read by the CR reader) and on the other hand disposes of the telephone number received from the trusted server (via the mobile equipment). This server is called a trusted server because one would avoid that any other service can send back this telephone number and for that purpose the trusted server adds identification data to the message transmitted to the matching terminal, the message that also contains the telephone number.

The matching terminal disposes of two information to be associated such as the unique number UA and the telephone number TEL. These two information can be transmitted in a second step to a centralized service (the matching server for example) in order for the recognition readers to have access to this information.

The secure association of a telephone number and a personal card number opens the way for numerous applications. In fact, the purchase of a ticket for an event is already possible by telephone. Once the purchase has been made, the number of the caller is used as a key for access to the show. The personal card, by indicating the telephone number of the owner, allows this access.

Another advantage of this situation is the possibility of loading the data without risk into the personal object for other applications. A shop can for example offer such an object in the form of a customer card and add data pertaining to the needs of the customer into said card, such as for the example payment using the customer card.

This allows, for example, a client to let himself be known at the time of entering a shop. The latter has a message server in close connection with the wireless telephony operators. Messages are diffused to recognized telephones numbers at the time of passing through these terminals which are located at the entrance of the shop.

Improved services can be offered such as the notification that ordered products are available when the client is recognized on the interior of the shop. This avoids the situation in which the customer must approach a counter to be told that unfortunately the shirt ordered is still not arrived.

According to one embodiment, the non-contact card is a simple electronic label that is so thin that it can be stuck to the back of a mobile telephone. This type of label includes an antenna and a chip storing the data.

Therefore, within the scope of this application, a system to send messages to a set of mobile equipment unit users is proposed, this unit being determined on the basis of the recognition of the personal card by one or more readers provided for this purpose.

The telephone numbers, or more generally their mobile equipment address if it concerns a portable computer, are transmitted to a message server. This server can be connected to users by several broadcast antennas. The concept of local area can encompass the broadcast area of more than one antenna.

The transmitter(s) defining the broadcast area have a first set of users connected. On this set, a sub-set has been recognized as desiring the extended services. This recognition is carried out thanks to the personal card.

To leave this sub-set, the user has of course the possibility to lets read his personal card a second time.

In case of the use of a contactless detection system, distances of 50 cm to 1 m are possible. The presence of two security detection gates allows the determination of whether the user enters or leaves the additional services area.

Another simple method is to recognize the same user on a mobile communication antenna outside the diffusion area. Therefore, it is possible to be sure that the user has left the area.

This invention can be used in close collaboration with biometric recognition systems. By biometric system it is meant systems such as voice recognition, fingerprint recognition, iris recognition or olfactory detection.

Instead of reading a unique number of the personal object, the matching terminal registers the biometric data of the user at the same time as the communication between the mobile equipment and the matching server. The reader is replaced with a fingerprint detector, for example.

Therefore, it is this biometric data that is associated to the telephone number in the matching database of the server SA.

During the identification of a user by a recognition terminal, the user introduces his biometric data, such as a vocal text and the data captured by the terminal is transmitted to the matching server in order to determine to which user it pertains. Once this determination has been carried out, the database server allows the association of the user's telephone number.

1. Matching method between mobile equipment comprising data relating to its identification and a personal object of identification comprising at least a unique number, this method being carried out by a matching terminal and comprising the following steps:
reading the unique number of the personal object by a reader of the matching terminal,
initializing a communication between the mobile equipment and the matching server,
generating a unique code by the matching terminal and transmitting it to the mobile equipment,
transmitting this unique code by the mobile equipment towards the matching server,
detecting and storing the data relating to the identification of the mobile equipment by the matching server,
transmitting the unique code and the unique number to the matching server by the terminal,
associating the unique number of the personal object with the data relating to the identification of the mobile equipment.

2. Matching method according to claim 1, wherein the unique code is visually generated by the matching terminal and introduced by the user on its mobile equipment.

3. Matching method according to claim 1, wherein the unique code is generated using audio tone by the matching terminal thanks to a loudspeaker of the terminal and transmitted on the microphone of the mobile equipment.

4. Matching method according to claim 1, wherein the matching terminal transmits as a unique code the unique number of the personal object.

5. Matching method according to claim 1, wherein the unique code is different to the unique number.

6. Matching method according to claim 5, wherein the matching terminal transmits the unique code and the unique number to the matching server, the server associates the unique number to data related to the identification of the mobile equipment thanks to the unique code.

7. Matching method according to one of the claim 1, wherein the personal object is a card with a bar code, a magnetic card or a contactless read only card.

8. Matching method according to claim 1, wherein the personal object comprises a writeable memory and in that the matching server transmits the data relating to the identification of the mobile equipment to the terminal that loads said data into the memory of the personal object.

9. Matching method according to claim 8, wherein the data relating to the identification of the mobile equipment is transmitted by the matching server to the mobile equipment thanks to the emission of audio codes, said codes being interpreted by the matching terminal.

10. Matching method according to claim 8, wherein the data relating to the identification of the mobile equipment is transmitted by the matching server to the matching terminal by sending a message comprising at least the unique code and the data relating to the identification of the mobile equipment.

11. Matching method according to one of the claim 8, wherein the personal object is a contact smart card, a contactless smart card or any form of electronic label.

12. Matching method according to the claim 8, wherein the data relating to the identification of the mobile equipment is signed by a private key, this signature is loaded into the memory of the personal object.

13. Matching method between mobile equipment comprising data relating to its identification and a personal object of identification comprising at least a unique number, this method being carried out by a matching terminal and comprising the following stages:
reading the unique number of the personal object by a reader of the matching terminal,
initializing a communication between the mobile equipment and the matching server,
detecting by the matching server the identification of the mobile equipment,
transmitting by the matching server the identification of the mobile equipment to the matching terminal through the mobile equipment by using audio codes,
associating by the matching terminal the unique number of the personal object with the identification of the mobile equipment.

14. Matching method according to one of the claim 13, wherein the personal object is a card with a bar code, a magnetic card or a contactless read only card.

15. Matching method according to claim 13, wherein the personal object comprises a writeable memory and in that the matching server transmits the data relating to the identification of the mobile equipment to the terminal that loads said data into the memory of the personal object.

16. Matching method according to the claim 15, wherein the data relating to the identification of the mobile equipment is signed by a private key, this signature is loaded into the memory of the personal object.
